(19) United States
(12) Patent Application Publication
(10) Pub. No.: US 2023/0022267 A1
(43) Pub. Date: Jan. 26, 2023

(54) PRECIOUS METAL RECOVERY FROM CARBON FINES

(71) Applicant: WATERCARE INNOVATIONS (PTY) LTD, Randfontein (ZA)

(72) Inventor: Tresha Motilal, Randfontein (ZA)

(21) Appl. No.: 17/787,506

(22) PCT Filed: Dec. 18, 2020
(86) PCT No.: PCT/ZA2020/050070

§ 371 Date: Jun. 20, 2022

(30) Foreign Application Priority Data
Dec. 20, 2019 (ZA) 2019/08517

(51) Int. Cl. C22B 3/24; C22B 3/16; C22B 3/42; C22B 3/22; C22B 11/00

(52) U.S. Cl. CPC C22B 3/24; C22B 3/165; C22B 3/42; C22B 3/22; C22B 11/04

(57) ABSTRACT

A method for the recovery of a precious metal from activated carbon fines which includes the steps of adsorption of the precious metals from the activated carbon fines onto a weak-base anion exchange resin which contains guanidine functional groups in the presence of at least one suitable lixiviant, or adsorption of the precious metals from activated carbon fines onto a mixed-base resin which contains amine functional groups in the presence of at least one suitable lixiviant and eluting the resin with a suitable eluant to produce a precious metal-containing eluate.

### BACKGROUND OF THE INVENTION

The invention relates to a method of recovering precious metals, such as gold and silver from carbon fines.

Gold recovery processes using carbon-in-pulp (CIP) and carbon-in-leach (CIL) are well known across the world due to the robustness of the technology. The precious metal, i.e. gold and silver, is recovered onto the carbon adsorbent material. The carbon is then separated from the pulp and undergoes an elution process for the recovery of the precious metal. Once eluted, the carbon is regenerated using high temperature kilns, prior to re-use in the CIP and CIL adsorption process.

Attrition of the activated carbon adsorbent material with the pulp, by mechanical processes such as pumping and screening, and by high temperature regeneration and chemical processes, results in the break-down of the carbon into fine carbon fractions. Some of the carbon fines pass through sizing screens and are lost to tailings, while a portion of the fines is recovered, mainly from the carbon transfer and elution processes.

Fine carbon gold grades can range between 10-2500 g/t and quantities of carbon captured can vary significantly, depending on the ore grade being treated, quality of carbon as well as the ore throughput.

The carbon fines may also be present as a waste stream generated from re-mining of tailings dumps.

The treatment of the carbon fines is usually outsourced by the gold producer and a typical industrial process route involves incineration followed by leaching of the resultant ash. The main shortcomings with this process are as follows:
(a) it is an energy intensive process, requiring temperatures of between 600° C. and 800° C. and the operational costs for incinerators are substantial;
(b) the capital and maintenance costs for incinerators are high;
(c) there can be soluble gold losses to the flue gas thereby reducing the overall recovery of the precious metal;
(d) high temperatures can cause encapsulation of the gold making it less amenable to leaching; hence additional processing by milling, prior to leaching, may be necessary;
(e) due to the high cost of treatment and lower overall gold recovery, the value realised by the gold producer is substantially lower than the value of the gold on the fine carbon material;
(f) often the gold producer experiences extensive delays in realising the revenue from the precious metal contained in the fine carbon; and
(g) the carbon fines must be transported from the gold producer to the industrial incineration plant and therefore requires extensive security and thus transportation costs.

It is an aim of the current invention to provide a processing technology using ion exchange resins suitable for recovering precious metals from carbon fines.

It is another aim of the invention to provide a lixiviant suitable for use with the resin products.

It is a further aim of the invention to provide a method of recovering gold from the loaded resin using a suitable eluant.

### SUMMARY OF THE INVENTION

The invention provides a method for the recovery of a precious metal from activated carbon fines which includes the steps of:
(a) adsorption of the precious metals from the activated carbon fines onto a weak-base anion exchange resin which contains guanidine functional groups in the presence of at least one suitable lixiviant, or
(b) adsorption of the precious metals from activated carbon fines onto a mixed-base resin which contains amine functional groups in the presence of at least one suitable lixiviant; and
(c) eluting the resin with a suitable eluant to produce a precious metal-containing eluate.

The precious metal may be silver or gold.

The lixiviant used may be a combination of an alkaline cyanide solution, a neutralising reagent and an organic reagent such as diesel.

The alkaline cyanide solution may be a sodium or a metal cyanide reagent.

The neutralising reagent may be caustic or lime.

Loading of the weak-base guanidine resin or the mixed-base amine resin in the lixiviant may be done in a resin-in-leach (RIL) process.

The elution of the precious metal loaded onto the weak-base guanidine resin or mixed-base amine resin may be done with a sodium hydroxide eluant which contains any one of the following additives: sodium lauryl sulphate, 2-ethyl-hexanoic, benzoic acid, versatic acid, or any other organic carboxylic acid group forming salts such as 4-methylbenzoic acid sodium salt, sodium benzoate or sodium versatate.

The precious metal containing eluate may undergo further processing such as electrowinning, precipitation or cementation for final recovery of the precious metal.

The invention further extends to a lixiviant suitable for use in precious metal recovery from carbon fines in a RIL process using a weak-base guanidine ion exchange resin or a mixed-base amine ion exchange resin, the lixiviant including a cyanide solution, an alkaline neutralising agent and an organic blinding agent such as diesel.

### BRIEF DESCRIPTION OF THE DRAWINGS

The invention is further described by way of example with reference to the accompanying drawings wherein:

FIG. 1 is a flow diagram showing steps of a method for recovering precious metals from activated carbon fines according to the invention;

FIG. 2 is a graph depicting an equilibrium adsorption isotherm showing the efficiency of gold absorption onto a resin from carbon fines using a method according to the invention;

FIG. 3 is a graph depicting equilibrium adsorption data showing efficiency of gold adsorption using a method according to the invention at relatively low grade carbon fines;

FIG. 4 is a graph depicting an equilibrium elution isotherm, comparing gold elution efficiency from the resin using various eluants according to the invention; and

FIG. 5, FIG. 6 and FIG. 7 are graphs depicting gold elution breakthrough curves using the method of the invention.

### DETAILED DESCRIPTION OF THE INVENTION

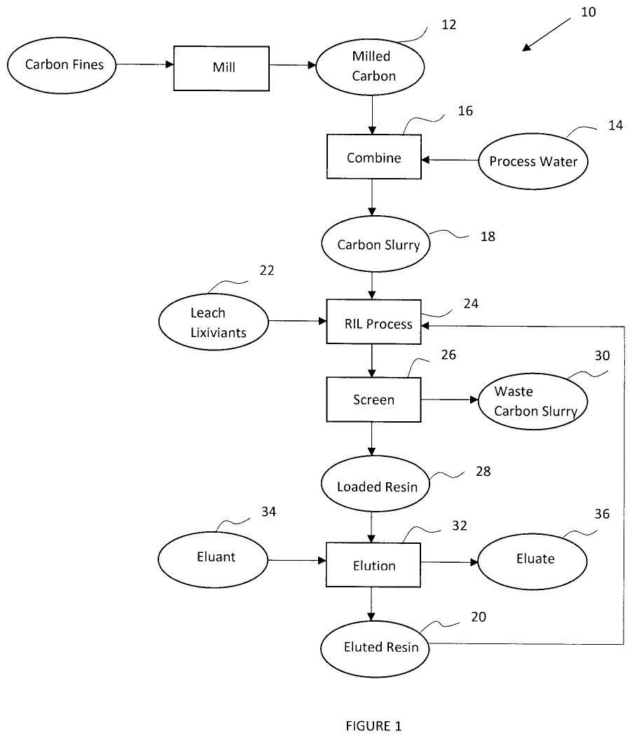

FIG. 1 is a flowsheet of a method 10 according to the invention which includes the steps of combining finely milled carbon 12 and process water 14 in a step 16 to produce fine carbon slurry 18.

The fine carbon slurry 18 is exposed to a weak-base guanidine resin or mixed-base amine resin 20 in the presence of a lixiviant 22 during an RIL process step 24.

Subsequently, a separation step 26 is carried out to remove a loaded resin 28 from a carbon waste slurry 30.

The loaded resin 28 is eluted in a step 32 by exposing the loaded resin 28 to a suitable eluant 34 to strip the precious metals into a resulting eluate 36 and to regenerate the resin 20 (eluted resin).

Assuming the gold-loaded fine milled carbon 12 is received dry, the process water 14 is added during the step 16 to make up the carbon slurry 18 containing 10-30% solids m/m. The carbon slurry 18 is then be leached using the lixiviant 22 containing sodium cyanide, caustic and diesel in the presence of the resin 20 to form the precious metal loaded weak-base guanidine resin or mixed-base amine resin in hydroxide form 28.

Following the step 24, the loaded resin 28 is separated in the step 26 from the waste carbon slurry 30 via screening.

The loaded resin 28 is then contacted with a hydroxide-based eluant 34 in the step 32 to form a gold-containing eluate 36.

The eluant 34 can be a sodium hydroxide eluant with a carboxylic acid additive such as sodium lauryl sulphate, 4-methylbenzoic acid forming salts such as 4-methylbenzoic acid sodium salt, sodium benzoate, sodium versatate or any other suitable eluant

The gold containing eluate 34 can be processed directly via electrowinning. The waste carbon slurry 28 can be disposed of in a tailings facility.

The eluted resin 20 is returned to the RIL process step 24 for adsorption of gold from carbon fines.

### EXPERIMENTAL RESULTS

### Carbon Head Grade

Fine carbon from 2 different sources was used for the test work, namely samples A and B. Sample B had a significantly higher metal loading compared to sample A, with gold grades at 655 g/t and 287 g/t respectively. Table 1 shows the loading of metals on the resin. Carbon samples A and B had a size fraction of 80% passing 105 μm.

TABLE 1

| Element | Sample A analysis, g/t | Sample B analysis, g/t |
|---|---|---|
| Au | 287 | 655 |
| Ag | 897 | 3745 |
| Al | 14233 | 14040 |
| Ca | 62385 | 73860 |
| Co | 45 | 70 |
| Cu | 304 | 545 |
| Fe | 20732 | 25030 |
| Ni | 1202 | 1640 |
| Zn | 278 | 350 |

### Equilibrium Adsorption Isotherm

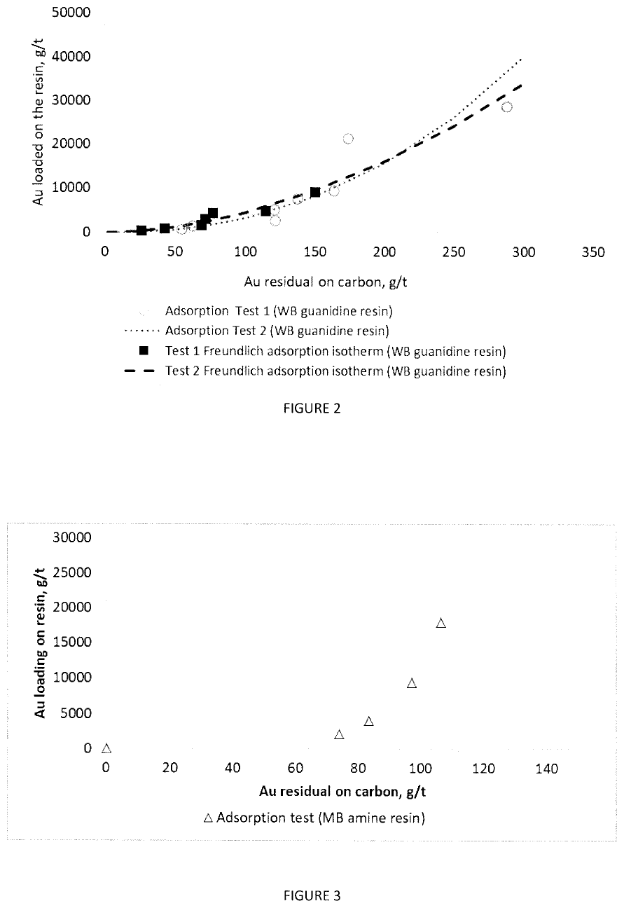

Carbon sample B was used to generate two equilibrium adsorption isotherms. The test work conditions were as follows: test temperature of 60° C., carbon slurry solids content of 25% m/m and contact time of 12 hours. The lixiviants used and resin are summarised in the Table below. Variable resin-slurry ratios were used to generate the equilibrium adsorption isotherm. On completion of the test, the carbon, resin and solutions were analysed. The equilibrium adsorption result is shown in FIG. 2.

TABLE 2

| | | Cyanide | Sodium | Diesel |
|---|---|---|---|---|
| | | concen- | Hydro- | concen- |
| | | tration | xide | tration |
| | | (added as | concen- | (blinding |
| | | NaCN) | tration | reagent) |
| Test ID | Resin Tested | mg/L | mg/L | mg/L |
| Adsorption | Weak-Base (WB) | 3 | 4 | 0 |
| Test 1 | guanidine | | | |
| Adsorption | Weak-Base (WB) | 1 | 4 | 4 |
| Test 2 | guanidine | | | |

The recovery of the gold from the carbon was effective. The leach and adsorption data are comparable for Test 1 and Test 2. It has been observed that the cyanide concentration can be reduced significantly with the addition of the diesel as a blinding reagent as this reagent allows the carbon to more effectively release the gold during leaching.

The addition of the blinding reagent is both a cost effective and a more environmentally acceptable option.

Carbon sample A was used to generate an equilibrium adsorption isotherm for the mixed-base amine resin. The test work conditions were as follows: test temperature of 60° C., carbon slurry solids content of 25% m/m and contact time of 12 hours. The lixiviant used was 3 g/L cyanide as sodium cyanide, and sodium hydroxide was used to maintain the leach between pH 10.2-10.5. Variable resin-slurry ratios were used to generate the equilibrium adsorption isotherm. On completion of the test, the carbon, resin and solutions were analysed. The equilibrium adsorption result is shown in FIG. 3.

The mixed-base amine resin was also effective in recovering the gold from the carbon. The mixed-base amine resin performed better than the guanidine resin under the same conditions. A resin loading of 17989 g/t was observed in equilibrium with a residual of 106 g/t on the carbon.

### Elution Equilibrium Isotherm

A gold solution generated during the stripping of various loaded resin from the leaching section was used to pre-load the weak-base guanidine resin and the mixed-base amine resin for elution testwork. The composition of the eluate can be seen in Table 3. This was done in a batch process at a pH 10.5. The gold loadings for the weak-base guanidine resin and the mixed-base amine resin were 840 mg/L and 621 mg/L respectively. The loaded resin was then used for the subsequent elution testwork. The elution equilibrium tests were conducted at 60° C. for 12 hours at variable eluant to resin ratios.

TABLE 3

| Element | Solution analysis, mg/L |
|---|---|
| Au | 60.4 |
| Ag | 178 |
| Al | 0.51 |
| Ca | 41.2 |
| Co | 0.63 |
| Cu | 8.9 |
| Fe | 9 |
| Ni | 7.6 |
| Zn | 0.88 |

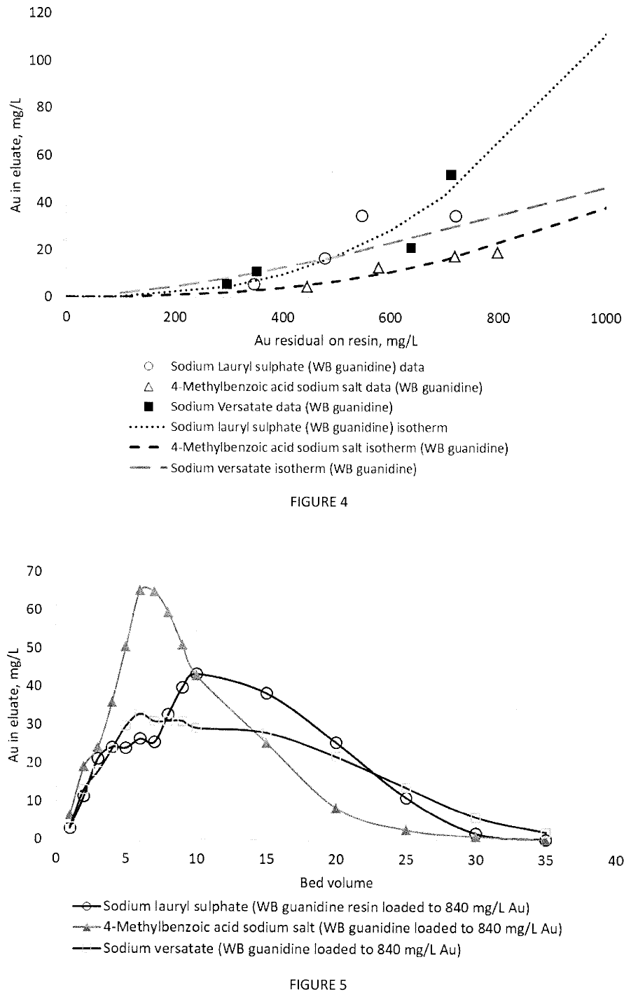

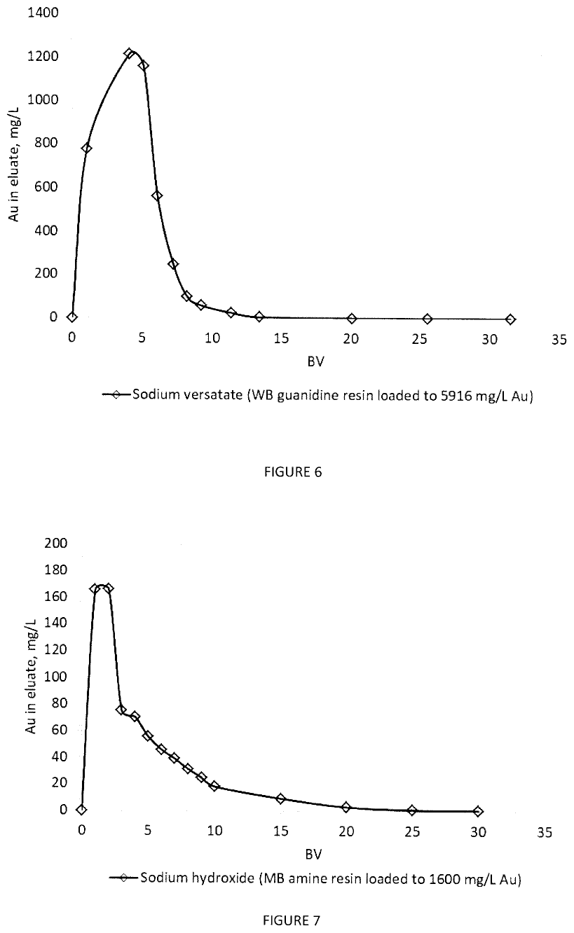

The weak-base guanidine resin elution was tested using sodium lauryl sulphate, 4-methylbenzoic acid sodium salt and sodium versatate in subsequent tests at a concentration of 0.35 mol/L carboxylic acid and 30 g/L sodium hydroxide. FIG. 4 shows the equilibrium elution data points which were fitted with a Freundlich equilibrium isotherm. Based on the data generated, sodium versatate performed best followed by sodium lauryl sulphate and 4-methylbenzoic acid sodium salt.

### Column Elution Test

The column elution test was done at a temperature of 60° C., at a flowrate of 3 BV/h. The gold loadings for the weak-base guanidine resin and 840 mg/L. Tests were done with sodium lauryl sulphate, sodium versatate and 4-methylbenzoic acid sodium salt at 0.35 mol/L carboxylic acid and sodium hydroxide at 30 g/L for each test. FIG. 5 illustrates the column elution test results. 4-methylbenzoic acid sodium salt performed the best achieving a peak concentration of 65 mg/L Au after 6 BV. The elution efficiencies for Au on all reagents ranged between 65-75% after 30 BV. This overall relatively low elution efficiency is as a result of the low Au loading of the resin.

A weak-base guanidine resin was pre-loaded with carbon sample B to a loading of 5916 mg/L. Elution was done using a 0.35 mol/L versatic acid and 30 g/L sodium hydroxide eluant composition. The column elution test was done at a temperature of 60° C., at a flowrate of 2 BV/h. FIG. 6 illustrates the elution profile obtained. The peak concentration achieved was 1200 mg/L Au in the eluate after 4 BV. An elution efficiency for Au of 87% was achieved after 9 BV. The initial Au loading on the resin has a significant impact on the elution efficiency of the resin.

The column elution test was done on a mixed-base amine resin at a temperature of 60° C., at a flowrate of 3 BV/h. The gold loading for the mixed-base amine resin was 621 mg/L. Tests were done with sodium hydroxide at a concentration of 30 g/L. FIG. 7 illustrates the column elution test results. A peak concentration of 166 mg/L Au after 2 BV with a elution efficiency of 91% achieved after 10 BV.

### BENEFITS OF THE INVENTION

Using RIL with the weak-base guanidine resin or mixed-base amine resin for the recovery of precious metals from carbon fines is a cost-effective process with lower capital and operating costs, compared to current incineration treatment processes.

High overall precious metal recoveries are achievable with this process route.

The gold eluate produced from the process is caustic-based and can fed directly into the existing carbon eluate stream to an electrowinning circuit.

High gold grades are achievable in the elution and hence there is minimal impact of dilution on the carbon eluate stream.

This process plant can be built as a module in an existing gold processing plant; therefore, the gold producer can realise the gold revenue immediately.

This process solution limits security risks and hence high transport costs as the fine carbon is treated onsite at the gold producer.

1. A method for the recovery of a precious metal from activated carbon fines which includes the steps of:
(a)(i) adsorption of the precious metals from the activated carbon fines onto a weak-base anion exchange resin which contains guanidine functional groups in the presence of at least one suitable lixiviant, or
(a)(ii) adsorption of the precious metals from the activated carbon fines onto a mixed-base resin which contains amine functional groups in the presence of at least one suitable lixiviant wherein the lixiviant is a combination of an alkaline cyanide solution, caustic or lime and an organic reagent which promotes the release of the precious metal from the carbon fines during leaching; and
(b) eluting the resin with a suitable eluant to produce a precious metal-containing eluate.

2. A method according to claim 1 wherein the precious metal is silver or gold.

3. A method according to claim 1 wherein the organic reagent is diesel.

4. A method according to claim 1 wherein the method is carried out at a temperature of 60° C.

5. A method according to claim 1 wherein the alkaline cyanide solution is a sodium or a metal cyanide reagent.

6. A method according to claim 1 wherein loading of the weak-base guanidine resin or the mixed-base amine resin in the lixiviant is done in a resin-in-leach (RIL) process.

7. A method according to claim 1 wherein the elution of the precious metal loaded onto the weak-base guanidine resin or mixed-base amine resin is done with a sodium hydroxide eluant which contains any one of the following additives: sodium lauryl sulphate, 2-ethyl-hexanoic, benzoic acid, versatic acid, or any other organic carboxylic acid group forming salts.

8. A method according to claim 7 wherein the organic carboxylic acid forming salts include 4-methylbenzoic acid sodium salt, sodium benzoate or sodium versatate

9. A method according to claim 1 wherein the precious metal containing eluate undergoes further processing including electrowinning, precipitation or cementation for final recovery of the precious metal.

10. A lixiviant suitable for leaching a precious metal from carbon fines in a resin-in-leach (RIL) process in the presence of a weak-base guanidine ion exchange resin or a mixed-base amine ion exchange resin, the lixiviant including a cyanide solution, an alkaline agent and an organic blinding agent.

11. A lixiviant according to claim 9 wherein the organic blinding agent is diesel.

12. (canceled)
